(19) United States
(12) Patent Application Publication
(10) Pub. No.: US 2005/0011815 A1
(43) Pub. Date: Jan. 20, 2005

(54) Apparatus for automatic nut inspection

(76) Inventor: Chi Cheng Jeh, Niaosong Shiang (TW)

Correspondence Address: Keith Kline;PRO-TECHTOR INTERNATIONAL, 20775 Norada Court, Saratoga, CA, 95070-3018, US

(21) Appl. No.: 10/832,647

(22) Filed: Apr. 26, 2004

(30) Foreign Application Priority Data
Apr. 30, 2003 (TW) 092206986

(51) Int. Cl. B07C 5/00

(52) U.S. Cl. 209/576

(57) ABSTRACT

This invention relates to an apparatus for automatic nut inspection. With sets of examining device of the present invention, nuts are carried by conveyer through the examining device and images of nuts are captured by camera to compare standards in computer. Any substandard nut, with less quality of welds, average area of welds, height of welds, dirt, cracks, diameter, threads, number of threads, thread diameter and height, will be weeded out from the conveyer to avoid mixing with goods.

### BACKGROUND OF THE INVENTION

1. Field of the Invention

The present invention relates to an automatic apparatus for nut inspection, and particularly to an apparatus which automatically examines standards, comprising welds, average area of welds, height of welds, dirt, cracks, diameter, threads, numbers of threads, thread diameter, and height, of examined nuts.

2. Description of the Related Art

Nowadays wide using nuts are manufactured in mass production by shaping. Some of nuts are made by welding to form some point for special usage. Those nuts should be examined to satisfy qualities and standards.

In the past nut mass production is only inspected by manual and/or visual with measuring gauge in sampling, only ratio of quality can be controlled. Even recently manufacturers use some automatic inspection apparatus to examine standards of nuts, these apparatus are still complex and hard to operate, and automation is too poor to promote efficiency.

### SUMMARY OF THE INVENTION

This present invention discloses an apparatus that can examine nuts automatically. A conveyer carries mass nuts moving one by one, and sets of examining device are installed on the pathway of the conveyer. Nuts are carried through the examining devices to examine standards, comprising welds, average area of welds, height of welds, dirt, cracks, diameter, threads, number of threads, thread diameter, and height, automatically and efficiently. Any examined substandard nut will be picked out and eliminated. Inspection of each nut is completed after it has passed through conveyer; no further examining is needed and no substandard nuts remain in goods.

### BRIEF DESCRIPTION OF THE DRAWINGS

FIG. 1 is a diagram illustrating an embodiment of apparatus of the present invention in topside view.

FIG. 2 is a diagram illustrating an embodiment of first examining device of the present invention in a lateral view.

FIG. 3 is a diagram illustrating an embodiment of second examining device of the present invention in a lateral view.

FIG. 4 is a diagram illustrating an embodiment of third examining device of the present invention in a lateral view.

### DETAILED DESCRIPTION OF THE PREFERRED EMBODIMENTS

In the following description of the preferred embodiments of the present invention, please refer to the drawings mentioned below.

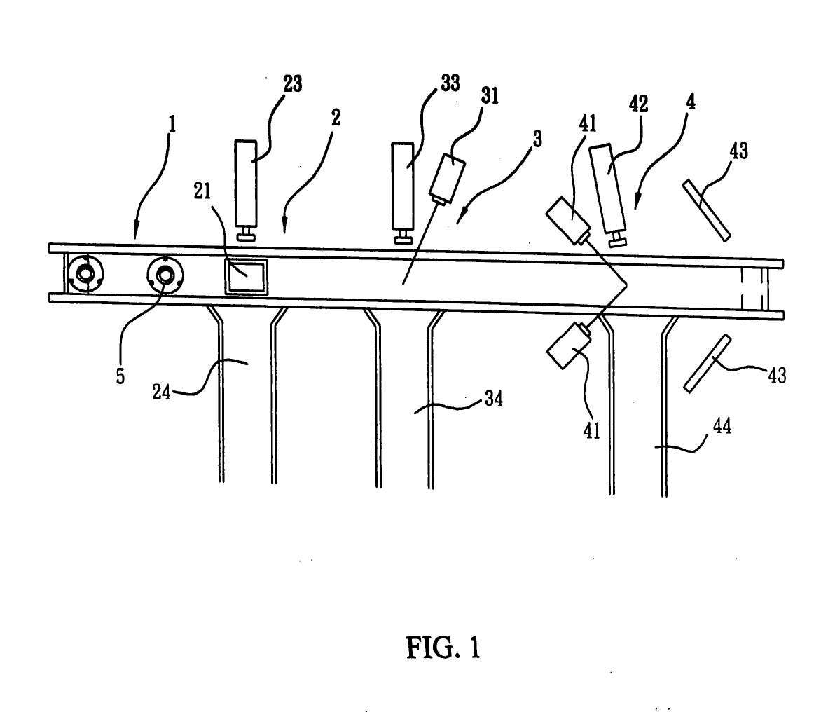

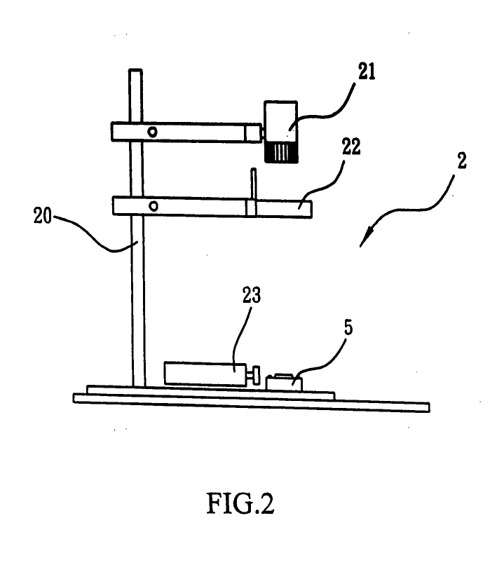

FIG. 1 and FIG. 2 illustrate the embodiment of the present invention, comprising a conveyer 1, a first examining device 2, a second examining 3, and a third examining device 4. Said conveyer, driven by a motor, carries nuts moving in particular direction. Manufactured nuts 5 are carried on said conveyer 1 one by one in line.

Referring to FIG. 2, said first examining device 2 is installed above said conveyer 1, and at the front position of moving direction of said conveyer 1. Said first examining device 2 comprises a first camera 21 and a first light source 22, which are installed fixed on a vertical pillar 20; said first camera 21 faces the direction of said conveyer 1, and is above said first light source 22. Said first examining device 2 further comprises a first pneumatic cylinder set 23 located at one lateral side of said conveyer 1, and a corresponding first chute 24 located at another lateral side of said conveyer 1. When said nut 5 moves to said first examining device 2, said first light source 22 illuminates upside of said nut 5; said first camera 21 captures image of upside of said nut 5, and transfers to computer (not shown in figure) to compare quality of welds, average area of welds, dirt, cracks, and diameter of said nut 5 with standards by program. Substandard nuts will be pushed out of said conveyer 1 to said first chute 24 by action of said first pneumatic cylinder set 23 to be collected, and others which pass inspection of said first examining device 2 are carried to a second examining device 3.

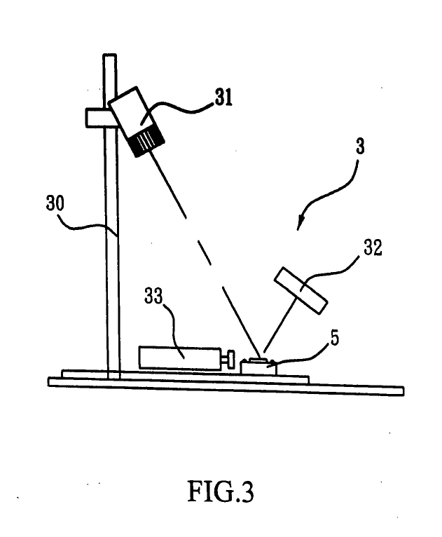

Referring to FIG. 1 and FIG. 3, said second examining device 3 comprises a second camera 31 and a second light source 32; said second camera 31 is fixed obliquely on a vertical pillar 21 to face the direction of said conveyer 1, and said second light source 32 is also fixed obliquely on appropriate lateral position of said conveyer 1 and above said conveyer 1. Said second examining device 3 further comprises a second pneumatic cylinder set 33 located at one lateral side of said conveyer 1, and a corresponding second chute 34 located at another lateral side of said conveyer 1. When said nut 5 moves to said second examining device 3, said second light source 32 illuminates lateral side and upside of said nut 5,; said second camera 31 captures image of lateral side and upside of said nut 5, and transfers to computer (not shown in figure) to compare quality of threads, number of threads, and thread diameter of said nut 5 with standards by program. Substandard nuts will be pushed out of said conveyer 1 to said second chute 34 by action of said second pneumatic cylinder set 33 to be collected, and others which pass inspection of said second examining device 3 are carried to a third examining device 4.

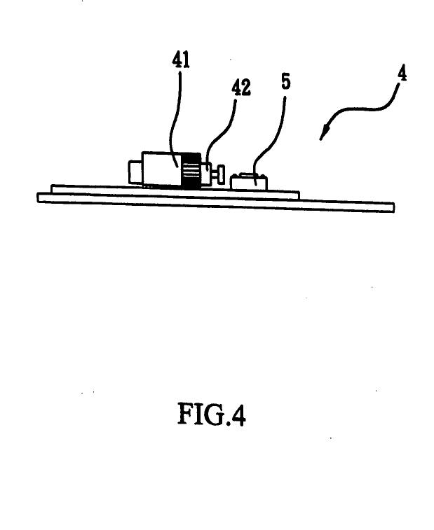

Referring to FIG. 1 and FIG. 4, said third examining device 4 comprises two third cameras 41 which are installed at each side of said conveyer 1 symmetrically, a third pneumatic cylinder set 42 located at one lateral side of said conveyer 1, and a corresponding third chute 44 located at another lateral side of said conveyer 1. Two backlighting plates 43 are set at appropriate positions corresponding to said two third cameras 41 as plain background to avoid misjudgement when said two third cameras 41 capture image of said nut 5. When said nut 5 moves to said third examining device 4, said two third cameras 41 capture image of lateral side of said nut 5 simultaneously, and transfer to computer (not shown in figure) to compare quality of height of nut and weld with standards by program. Substandard nuts will be pushed out of said conveyer 1 to said third chute 44 by action of said third pneumatic cylinder set 42 to be collected, and others which pass inspection of said third examining device 4 are carried to outlet to be collected as goods.

The foregoing describing of the preferred embodiment of the invention is for the purposes of illustration and description. It is not intended to exhaust or to limit the invention to the precise from disclosed. Many other possible modifications and variations can be made without departing from the scope of the present invention, which following claims are depended upon.

1. An apparatus for automatic nut inspection comprises:
a. a conveyer,
b. a plurality of sets of examining device;
which are characterized in that said examining devices are set along said conveyer in order, and each comprises 1 or 2 cameras, a light source, and a pneumatic cylinder set, wherein said camera captures image of nut with illumination of said light source to computer to examine standard by program, and said pneumatic cylinder set pushes substandard nut out of said conveyer.

2. The apparatus for automatic nut inspection according to claim 1, wherein said camera and said light source are installed above said conveyer.

3. The apparatus for automatic nut inspection according to claim 1, wherein said camera and said light source are installed oblique above said conveyer.

4. The apparatus for automatic nut inspection according to claim 1, wherein said 2 cameras are installed on both symmetrical sides of said conveyer.

5. The apparatus for automatic nut inspection according to claim 1, wherein said examining device comprises backlighting plates in front of lens of said cameras.

6. The apparatus for automatic nut inspection according to claim 1, wherein said examining device captures upside image of nut by said camera to examine standards comprising welds, average area of welds, dirt, cracks, and diameter of nut.

7. The apparatus for automatic nut inspection according to claim 1, wherein said examining device captures lateral side and upside image of nut by said camera to examine standards comprising threads, number of threads, and thread diameter of nut.

8. The apparatus for automatic nut inspection according to claim 1, wherein said examining device captures side image of nut by said camera to examine standards comprising height of nut and weld.

9. The apparatus for automatic nut inspection according to claim 1, wherein said conveyer is installed with chutes at lateral side of each said set of examining device.

10. An apparatus for automatic nut inspection comprises:
a. a conveyer,
b. a first examining device, which comprises a first camera, a first light source, and a first pneumatic cylinder set, wherein said first camera and said first light source are installed above said conveyer capturing upside image of nut by said first camera with illumination of said first light source to computer to examine standards comprising welds, average area of welds, dirt, cracks, and diameter of nut, and said first pneumatic cylinder set pushes substandard nut out of said conveyer.
c. a second examining device, set after the first examining device, which comprises a second camera, a second light source, and a second cylinder pneumatic set, wherein said second camera and said second light source are installed obliquely above said conveyer capturing lateral side and upside image of nut by said second camera with illumination of said second light source to computer to examine standards comprising threads, number of threads, and thread diameter of nut, and said second cylinder pneumatic set pushes substandard nut out of said conveyer.
d. a third examining device, set after the second examining device, which comprises two third cameras, two backlighting plates, and a third pneumatic cylinder set, wherein said third cameras are installed with said backlighting plates in front of lens of said third cameras on both symmetrical sides of said conveyer capturing side image of nut by said third cameras to computer to examine standards comprising height of nut and weld, and said third cylinder pneumatic set pushes substandard nut out of said conveyer.

11. The apparatus for automatic nut inspection according to claim 10, wherein said conveyer is installed with a first chute at lateral side of said first examining device.

12. The apparatus for automatic nut inspection according to claim 10, wherein said conveyer is installed with a second chute at lateral side of said second examining device.

13. The apparatus for automatic nut inspection according to claim 10, wherein said conveyer is installed with a third chute at lateral side of said third examining device.
